(19) United States
(12) Patent Application Publication
(10) Pub. No.: US 2010/0327092 A1
(43) Pub. Date: Dec. 30, 2010

(54) ACTIVE STRIPPER ELEMENTS FOR SHREDDER ASSEMBLY

(75) Inventor: Dmitry Romanovich, Glen Ellyn, IL (US)

Correspondence Address: PILLSBURY WINTHROP SHAW PITTMAN, LLP, P.O. BOX 10500, MCLEAN, VA, 22102, US

(73) Assignee: Fellowes, Inc., Itasca, IL (US)

(21) Appl. No.: 12/493,893

(22) Filed: Jun. 29, 2009

(51) Int. Cl. B02C 19/00

(52) U.S. Cl. 241/25; 241/166

(57) ABSTRACT

A shredder assembly for use in a shredder includes a plurality of cutter elements provided in a spaced apart manner configured to shred an article; and a plurality of stripper elements, each positioned between neighboring cutter elements, that are configured to remove debris particles stuck on the sidewalls of the cutter elements and/or between neighboring cutter elements. In a first configuration, when the cutter elements are rotated in a forward direction, upper portions of the stripper elements are urged toward the article to be shredded. In a second configuration, when the cutter elements are rotated in a reverse direction, the upper portions of the stripper elements are urged away from the article to be shredded. A method for shredding is also disclosed.

### FIELD

This application generally relates to shredders for destroying articles, such as paper documents, compact disks, etc.

### BACKGROUND

Shredders are well-known devices for destroying articles such as documents, CDs, floppy disks, etc. Further, users purchase shredders to destroy sensitive articles, such as credit card statements with account information, documents containing company trade secrets, etc.

During shredding, debris particles may become stuck to the sidewalls of the cutter elements and/or lodged or wedged between neighboring cutter elements. This greatly reduces the efficiently of the shredding.

In some shredders, stripper elements have been provided in an effort to help remove the debris particles. The stripper elements are generally fixed with respect to the shredding assembly.

### SUMMARY

According to one embodiment, a shredder assembly is disclosed comprising: a plurality of cutter elements provided in a spaced apart manner configured to shred an article; and a plurality of stripper elements, each positioned between neighboring cutter elements, that are configured to remove debris particles stuck on the sidewalls of the cutter elements and/or between neighboring cutter elements, wherein the stripper elements are mounted for movement between: (i) a shredding configuration when the cutter elements are rotated in a forward direction, wherein upper portions of the stripper elements are urged toward an article to be shredded; and (ii) a reversing configuration, when the cutter elements are rotated in a reverse direction, the upper portions of the stripper elements are urged away from an article being reverse fed from the cutter elements.

According to one embodiment, a method of shredding is disclosed comprising: inserting an article to be shredded into a shredding assembly having a plurality of cutter elements provided in a spaced apart manner, and a plurality of stripper elements, each positioned between adjacent cutter elements, that are configured to remove debris particles stuck on the sidewalls of the cutter elements and/or between neighboring cutter elements, wherein when the cutter elements are rotated in a forward direction, upper portions of the stripper elements are urged toward the article to be shredded.

Other features of one or more embodiments of this disclosure will seem apparent from the following detailed description, and accompanying drawings, and the appended claims.

### BRIEF DESCRIPTION OF THE DRAWINGS

Embodiments of the present disclosure will now be disclosed, by way of example only, with reference to the accompanying schematic drawings in which corresponding reference symbols indicate corresponding parts, in which:

FIG. 1 shows an exemplary shredder constructed in accordance with an embodiment;

FIG. 2 shows a side view of a shredding assembly where the stripper elements are positioned in a first configuration configured to clear debris between neighboring cutting element during shedding in accordance with an embodiment;

FIG. 3 shows a side view of a shredding assembly where the stripper elements are positioned in a second configuration configured for article removal from the shredding assembly in accordance with an embodiment;

FIG. 4 shows a front view of the shredding assembly shown in FIGS. 2 and 3;

FIG. 5 shows a schematic of the forces acting of the shredding assembly while shredding an article, in accordance with an embodiment.

The use of primed reference symbols (i.e., ′) herein indicates a similar referenced elements or features that may be orientated and/or positioned differently than its non-primed counterpart.

### DETAILED DESCRIPTION

According to one aspect of the application, the shredding assembly may be provided with a plurality of moveable stripper elements to control paper flutter, improve cut quality, clean debris particle buildup and/or facilitate easy article jam removal.

The figures below show a range of motion of the stripper elements during forward and reverse directions of the cutter elements. As the article thickness or sheet count is increased, the force on the lower portion of the stripper elements increases causing the upper portion of the stripper elements to rotate inwardly reducing the article entry passage and thus, paper flutter. In a reverse direction the upper portions of the stripper elements rotate outward allowing easy paper removal.

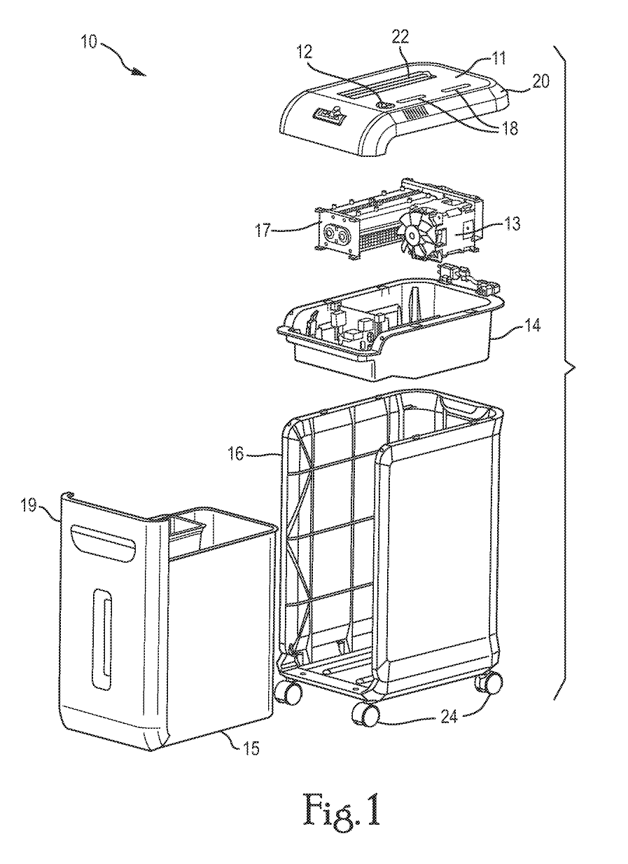

FIG. 1 depicts an exemplary shredder constructed in accordance with an embodiment.

The shredder is generally indicated at 10. The shredder 10 includes a housing 20 having an opening or throat 22 for receiving at least one article 31 to be shredded, a shredding assembly 17 received in the housing 20, and a controller (not shown) coupled to an electrically powered motor 13. The shredding assembly 17 includes the motor 13 and cutter elements. The shredding assembly 17 enables articles to be shredded to be fed into the cutter elements. The motor 13 is operable to drive the cutter elements so that the cutter elements shred the articles fed therein.

As noted above, the shredder 10 includes the shredder housing 20. The shredder housing 20 includes a top cover or wall 11, and a bottom receptacle 14. The top cover or wall 11 is configured to sit atop the upper periphery of the bottom receptacle 14. The top cover or wall 11 is molded from a plastic material or any other material. The shredder housing 20 and its top cover or wall 11 may have any suitable construction or configuration. The top cover or wall 11 has an opening, which is often referred to as the throat 22, extending generally parallel and above the cutter elements. The throat 22 enables the articles being shredded to be fed into the cutter elements. As can be appreciated, the throat 22 is relatively narrow, which is desirable for preventing overly thick items, such as large stacks of documents, from being fed into cutter elements, which could lead to jamming. The throat 22 may have any configuration.

The bottom receptacle 14 of shredder 10 includes a bottom wall, four side walls and an open top. The bottom receptacle 14 may be molded from a plastic material or any other material. The bottom receptacle 14 sits atop the upper periphery of the bottom housing 16 in a nested relation using flange portions of the bottom receptacle 14 that generally extend outwardly from the side walls thereof. The shredding assembly 17 along with the motor 13 are configured to be received in the bottom receptacle 14 of the shredder housing 20. The bottom receptacle 14 may be affixed to the underside of the top cover or wall 11 by fasteners. The receptacle 14 has an opening in its bottom wall through which the shredding assembly 17 discharges shredded article debris into the container 15.

As noted above, the shredder 10 includes the shredding assembly 17 that includes the electrically powered motor 13 and a plurality of cutter elements. The term “shredding assembly,” as used herein, denotes a device that destroys articles using at least one cutting element. Such destroying may be performed in any particular way, such as by strip cutting, cross cutting, or the like. For example, the shredding assembly may include at least one cutting element that is configured to cut, punch, and/or rip a plurality of holes in the document or article in a manner that destroys the document or article. In the illustrated embodiment, the cutter elements are generally mounted on a pair of parallel rotating shafts. The motor 13 operates using electrical power to rotatably drive the shafts and the cutter elements through a conventional transmission so that the cutter elements shred articles fed therein. The shredding assembly 17 may also include a sub-frame for mounting the shafts, the motor 13, and the transmission.

In the illustrated embodiment, the shredder 10 sits atop the large freestanding housing 16, which is formed of molded plastic material or any other material. The housing 16 includes a bottom wall, three side walls, an open front and an open top. The side walls of the container 16 provide a seat on which the shredder housing 20 is removably mounted. The housing 16 is constructed and arranged to receive the waste container 15 therein. In other words, the waste container 15 is enclosed in the housing 16. The waste container 15 is formed of molded plastic material or any other material. In some implementations, the waste container 15 may be a pull-out bin that is constructed and arranged to slide in and out of the housing 16 through an opening in the front side thereof. The waste container 15 is configured to be removably received within the housing 16. The waste container 15 may also include a handle 19 that is configured to allow a user to grasp and pull out the waste container 15 from the housing 16. In the illustrated embodiment, the handle 19 is located on the front, side wall of the waste container 15. As an option, the housing 16 along with the shredder 10 can be transported from one place to another by simply rolling the housing 16 on roller members 24, such as wheels or casters.

The cover 11 may include a switch 12 recessed with an opening therethrough. For example, an on/off switch 12 that includes a switch module may be mounted to the top cover 11 underneath the switch recess by fasteners, and a manually engageable portion that moves laterally within the switch recess. The switch module has a movable element that connects to the manually engageable portion through the opening. This enables movement of the manually engageable portion to move the switch module between its states.

The switch module 12 is configured to connect the motor 13 to the power supply. This connection may be direct or indirect, such as via a controller. Typically, the power supply will be a standard power cord with a plug on its end that plugs into a standard AC outlet. The switch 12 may be movable between an on position and an off position by moving the manually engageable portion laterally within the switch recess. In the “on” position, contacts in the switch module are closed by movement of the manually engageable portion and the movable element to enable a delivery of electrical power to the motor 13. The motor 13 will be driven in a forward manner so as to drive the cutter elements for a shredding operation.

In the “off” position, contacts in the switch module are opened to disable the delivery of electric power to the motor 13. Alternatively, the switch 12 may be coupled to a controller, which in turn controls a relay switch, for controlling the flow of electricity to the motor 13, as will be described in detail below.

The switch 12 may also have a “reverse” position wherein contacts are closed to enable delivery of electrical power to operate the motor 13 in a reverse manner. This would be done by using a reversible motor and applying a current that is of a reverse polarity relative to the on position. The capability to operate the motor 13 in a reversing manner is desirable to move the cutter elements in a reversing direction for clearing jams. In the “off” position the manually engageable portion and the movable element would be located generally in the center of the switch recess, and the “on” and “reverse” positions would be on opposing lateral sides of the “off” position.

Generally, the construction and operation of the switch 12 for controlling the motor 13 are well-known and any construction for such a switch may be used. For example, the switch 12 need not be mechanical and could be of the electro-sensitive type.

One or more display indicators 18 may be located on the cover 11 (and/or on other locations of the shredder 10), for providing status to the user of one or features of the shedder 10. For example, the display indicators 18 may include one or light emitting diodes (LED), liquid crystal displays (LCD), speakers, lamps, gauges, or other indicating means.

The shredder 10 may have any suitable construction or configuration and the illustrated embodiment is not intended to be limiting in any way. In addition, the term “shredder” is not intended to be limited to devices that literally “shred” documents and articles, but is instead intended to cover any device that destroys documents and articles in a manner that leaves each document or article illegible and/or useless.

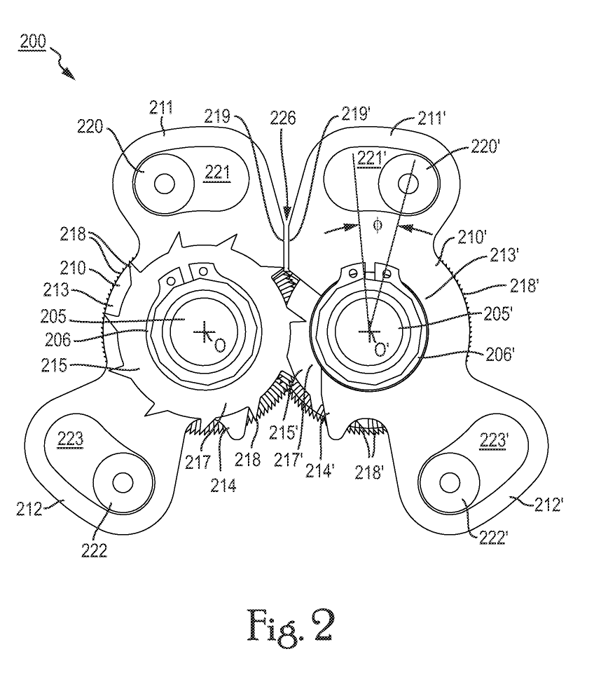

FIGS. 2 and 13 depict a side view of a shredding assembly for use in a shredder in accordance with an embodiment. The sub-frame of the shredding assembly, for example, as shown in FIG. 1, has been omitted from these the figures for clarity.

The shredding assembly generally includes a first set of stripper elements 210 and a second set of stripper elements 210′, which are configured to remove debris particles from a first set of cutter elements 215 and a second set of cutter elements 215′, respectively.

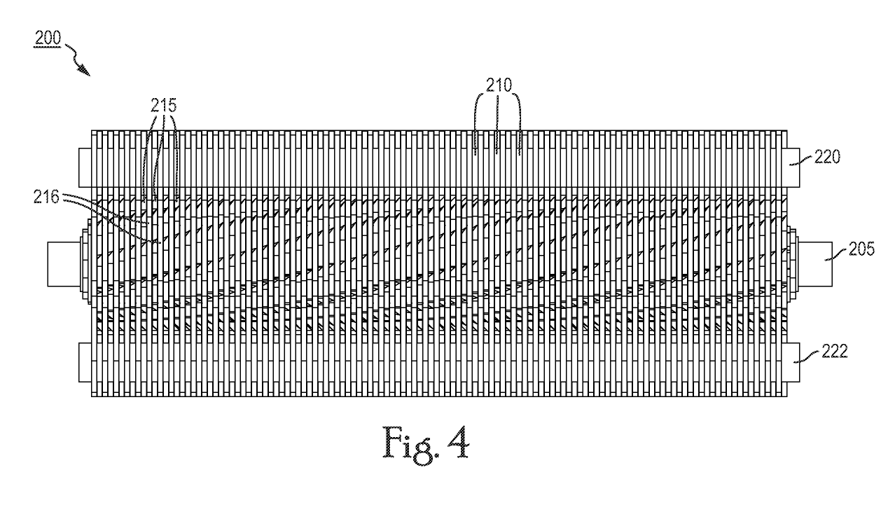

The cutter elements 215, 215′ may be staggered on respective shafts 205, 205′, such that the first step of cutter elements 215 elements extend within spaces 216 (FIG. 4) provided between neighboring cutter elements 215′ of the second set of cutter elements, and vice versa. The spaces 216 may be sized slightly larger than the width of the cutter elements 215, 215′. During shredding, the article to be shredded may be interleaved or meshed between the first and second sets of cutter elements for shredding.

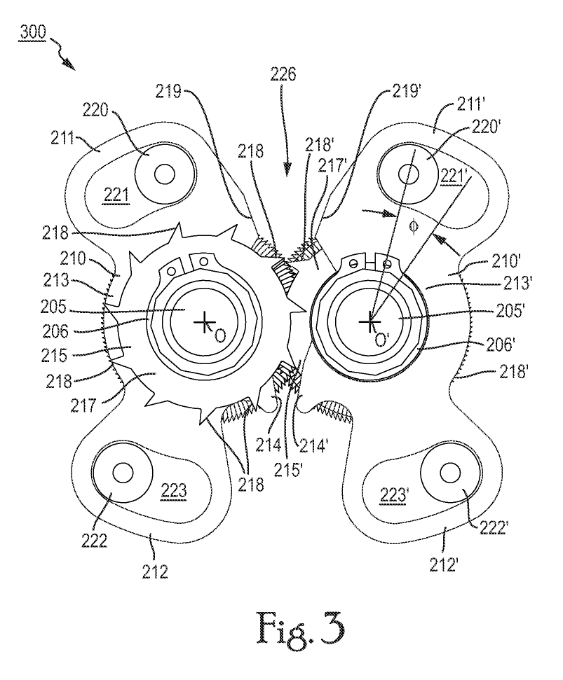

FIG. 2 shows the stripper elements 215, 215′ positioned in a first configuration 200 configured to clear debris between neighboring cutting element during shedding. And FIG. 3 shows the stripper elements 215, 215′ positioned in a second configuration 300 configured for article removal from the shredding assembly.

Each of the cutter elements 215, 215′ may have a body 217, 217′ having a generally circular cross-section with an opening for engaging a respective shaft 205, 205′. The cutter elements 215, 215′ may be spaced apart equally of the respective shaft, for example, approximately every 1 to 6 mm (e.g., 2, 3.9 or 5.8 mm depending on a desired configuration). For example, the central openings of the cutter elements may be sized so as to form an interference or press (frictional) fit with the respective shaft 205, 205′. In addition, the shafts and the cutter elements may include non-circular engaging features (e.g., hexagonal) for preventing relative rotation thereof. Other configurations and/or “keyed” connections are also possible.

The cutter elements 215, 215′ may be positioned on a respective shaft 205, 205′ and secured against axial movement on one or both of their sides, for example, with C-clip 206, 206′, which engage corresponding slots (not shown) in the shafts. Other axial securing mechanisms might similar be used.

The cutter elements 215, 215′ may be driven by rotating one or both of the respective shafts 205, 205′. The electric motor 13 as shown in FIG. 1, for instance, may be used. Shafts 205, 205′ could also be rotationally driven by other mechanisms, such as a hand crank or the like.

As an article, such as one or more sheets of paper, is inserted into the shredding assembly 200, the first and second sets of cutter elements 215, 215 pierce, cut and/or rip the article so as to shred it. The cutter elements 215, 215′ may be configured to perform strip cutting, cross cutting, or other shredding modes as known in the art. The cutter elements 215, 215′ have a plurality of projecting cutting teeth 218, 218′ suitable configured for shredding. In one implementation, as shown, the cutting teeth 218, 218′ may taper to a single cutting edge.

The term “forward direction,” as used herein, refers to the direction of rotation that the first and second sets of cutter elements rotate with respect to the article to be shredded during a shredding operation. The cutting teeth 218, 218′ of each of the first and second sets of cutter elements will be rotated forward so as to cut, pierce, rip, etc., the article to be shredded, although, the shafts 205, 205′ may be rotated in opposite directions with respect to the shedding assembly during shredding. For instance, during shredding the first set of cutter elements 215 may be rotated in the clockwise direction, while the second set of cutter elements 215′ may be rotated in the counterclockwise direction.

If a jam occurs and/or the user wishes to stop shredding and remove an the article from the shredding assembly, the first and second sets of cutter elements 215, 215′ may be driven in reverse. The term “reverse direction,” as used herein, refers to the direction of rotation of the first and second sets of cutter elements with respect to the article to shredded when the cutter elements are driven in an opposite direction of rotation from the “shredding direction.” The cutting teeth 218, 218′ of each of the first and second sets of cutter elements 215, 215′ will be rotated backwards so as to not cut, pierce, rip, etc. the article to be shredded, although, the shafts 205, 205′ may be rotated in opposite directions with respect to the shedding assembly. For instance, the first set of cutter elements 215 may be rotated in the counterclockwise direction, while the second set of cutter elements 215′ may be rotated in the clockwise direction,

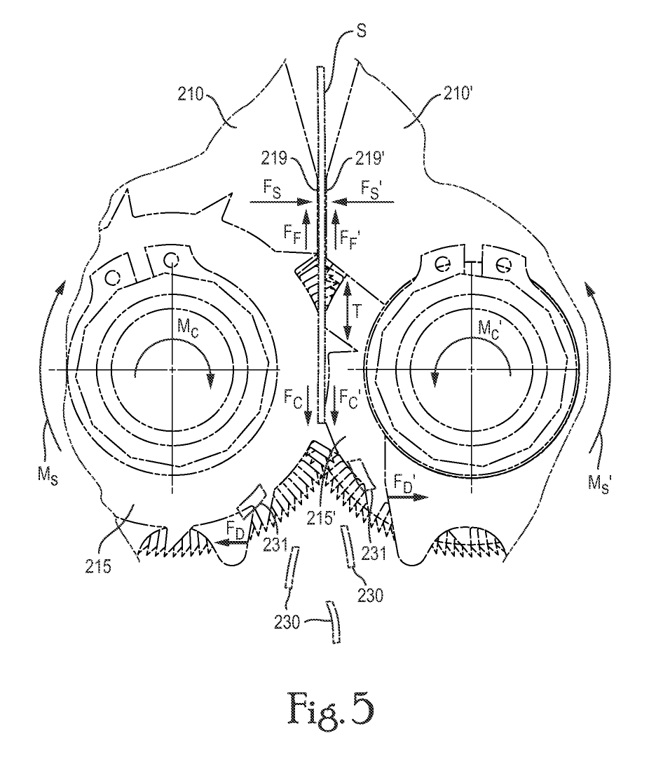

Debris particles 230 (FIG. 5) fall under their weight into the receptacle 15, as shown in FIG. 1. During cutting, some of the debris particles 231 (FIG. 5) may become stuck to sidewalls of the cutter elements and/or lodged or wedged between sidewalls of adjacent cutter elements of the first and second sets of cutting element 215, 215′. The stuck and wedged debris particles may reduce the effectiveness of the cutting or worse, such as jamming the shredder 10.

Positioned between the first and second sets of cutter elements are the first set of stripper elements 210 and the second set of stripper elements 210′, respectively. The stripper elements 210, 210′ are configured to remove debris particles that may stick to the sidewalls of the cutter elements and/or be wedged or lodged between of neighboring cutter elements 215, 215′. Stripper elements of the first set are spaced apart from cutter elements of the second set (and vice versa) so as to not interfere with each other.

As indicated in FIG. 2, each stripping element 210, 210′ generally includes a top portion 211, 211′ that is located above the shaft 205, 205′, a bottom portion 212, 212′ that is located generally below the shaft 205, 205′ and a central portion 213, 213′ located therebetween for engaging the shaft. As shown, the central portion 213, 213′ may have a semi-circular or C-shaped configuration which permits the stripping element to rotate about the shaft 205, 205′. In some implementations, the central portions 213, 213′ of the stripper elements may be provided with a suitable bearing structure or surface to reduce wear.

While the first and second sets of cutter elements 215, 215′ are fixed for rotation with the shafts, the stripper elements 210, 210′ may be free to move independently of the rotation of the shafts 205, 205′. For example, in one implementation, the pivotable points of the first and second set of stripper elements may coincide with an axis of rotation O, O′ of both the shafts 205, 205′ and the cutter elements 215, 215′.

The lower portions 212, 212′ of the stripper elements 210, 210′ may include a debris removal surface 214, 214′ which is configured to clear debris which may stick to the sidewalls of the cutter elements 215, 215′ and/or may be wedged or lodges between neighboring cutter elements 215, 215′. As the cutter elements rotate, the stuck or wedged debris particles contact the debris removal surface 214, 214′ of the stripper elements 210, 210′ thereby removing debris particles from the cutter elements 215, 215′. The removed debris particles may fall into the receptacle below.

In order to limit the range of rotational motion of the stripper elements, one or more stop mechanisms (“stops”) may be provided. The stops may include blocks, detents, pins, bars, bumpers, springs, or the like which are configured to limit and/or resist the range of motion of the stripper elements 215, 215′.

In one implementation, as shown in FIGS. 2, 3, the stops may include upper bars 220, 220′ and/or lower bars 221, 221. The upper and lower bars may be fixed with respect to the shredding assembly. Upper slots 221, 221′ and lower slots 223, 223′ may be provided on each of the upper and lower portions 211, 211′ of the stripper elements to receive the upper bar 220, 220′ and the lower bar 220′, respectively. Upper and lower slots may be sized appropriately so as to permit the stripper elements to freely displace, but limit their range of displacement. Each stripping element 215, 215′, for instance, may be configured to rotate about axis O, O′ by a predetermined angle Φ. In one embodiment, angle Φ may be approximately 20°.

Alternatively, the stops might be positioned outside of the confines of the stripping mechanisms so as to permit a similar range of motion. For example, the outer surface of the upper and lower portions of the stripper elements may contact the stop elements.

FIG. 2 shows the stripper elements 215, 215′ positioned in the first configuration 200 configured to clear debris between neighboring cutting element during shedding.

The upper portion 211, 211′ of the stripper elements 215, 215′ include an article bearing surface 219, 219′. The article bearing surfaces 219, 219′ of the first set of stripper elements 215 and the second set of stripper elements together form an article entry passage 226 for the article to pass through onto the cutter elements.

When the upper portions of the stripper elements 215, 215 are in the first configuration, the width of the article entry passage 226 is at a minimum with the respectively article bearing surface 219, 219 of the first and second sets being substantially parallel. The minimum width of the article entry passage 226, in the first configuration may be chosen to be approximately 1.5 to 3 times the rated sheets capacity. For example, on a 20 sheet shredder, the entry passage width may be between about 2.7 and 6 mm.

The stripper elements 215, 215′ may rotate passively by the shredded article acting against them. Considerable force may be required to strip or remove debris from the sidewalls of the cutter elements and/or from between neighboring cutter elements. This force acts upon the lower portions 212, 212′ of the stripper elements causes them to rotate outward thereby closing the opening of the article entry passage 216 to a minimum width. Increasing the article thickness (e.g., the sheet count) increases the article forces applied to the stripping element.

As the article entry passage 226 is reduced, contact with the article may improve the article shredding efficiency by placing tension force on incoming article. The reduced article entry helps to groom the article for more efficient flutter-free shredding. This is shown in more detail in FIG. 5, and described below.

Specifically, when the cutter elements 215, 215′ are driven in the forward direction, the stripper elements 210, 210′ will rotate into the first configuration 200 (FIG. 2), in which the top portions 211 of each of first set of stripper elements 215 is closest to the top portions of 211′ each of the second set of stripping element 215′. As shown, the left-most portion of the upper slots 221 of the first set of stripper elements 215 comes to the bear against the first shaft 220. Likewise, the right-most portion of the lower slots 223 of the first set of stripper elements 215 comes to the bear against the second shaft 222. The second set of stripping element 215′ may be oppositely situated from the first set of stripper elements 215.

FIG. 3 shows the stripper elements 215, 215′ positioned in the second configuration 300 configured for article removal from the shredding assembly.

The electric motor 13 may be reversed so as to reverse the direction of the shafts 205, 205′. In the reverse direction, the force due to debris removal is no longer present on the stripper elements 210, 210′. This reverse motion forces the article away from the cutter elements 215, 215′. And the article's movement away from the shredding assembly helps to wedge or push the top portions 211, 211′ of the stripper elements apart. As such, the width of the article entry passage 226 is maximized. For example, the maximum width of the article entry passage 226, in the second configuration may be chosen to be approximately 10 to 25 mm. Accordingly, the article entry passage 226 is enlarged sufficiently so that the article bearing surfaces 219, 219′ do not contact the article nor interfere with article removal from the shredding assembly.

In particular, the right-most portion of the upper slots 221 of the first set of stripper elements 210 comes to the bear against the first shaft 220. Likewise, the left-most portion of the lower slots 223 of the first set of stripper elements 210 comes to the bear against the second shaft 222. The second set of stripping element 210′ may be oppositely situation from the first set of stripper elements 210.

In some implementations, the stripper elements 210, 210′ might also be spring-loaded or otherwise biased to help rotate them to the second configuration. Alternatively, the stripper elements 210, 210′ could have limited-slip with respect to the shafts 205, 205′ so as to slightly urge them in the direction of the shaft.

FIG. 4 shows a front view of the shredding assembly shown in FIG. 2. As shown in this figure, the first set of cutter elements and the first set of stripper elements is visible as if looking from left to right in FIGS. 2 and 3.

The number of cutter elements 215, 215′ for each of the first and second sets of cutter elements may vary based on the desired configuration. For instance, there may be 63 cutter elements per shaft with a 2 mm cut width; 28 cutter elements per shaft with a 3.9 mm cut width; or 19 cutter elements per shaft with 5.8 mm cut width. The same number of stripper elements 210, 210′ may similar be provided. In one implementation, the overall length of the shafts 205, 205′ may be approximately 230 mm.

FIG. 5 shows a schematic of the forces acting of the shredding assembly while shredding an article, in accordance with an embodiment. For clarity, various elements of the shredding assembly are shown in dotted-line.

A user may insert an article, such as a sheet of paper S, into the shredding assembly to be shred. In order to operate the shredder, the user may use a switch (FIG. 1: 12) as noted above, to drive the motor. Moments M_{C}, M_{C}′ may be generated by the shafts 205, 205′, which drive the first and second sets of cutter elements 215, 215′ for shredding the sheet S. The first and second sets of cutting element 215, 215′ engage the sheet S, and begin shredding it. As the cutter elements 215, 215 shred the sheet S, they tend to pull downwardly on the sheet S to produce forces F_{C}, F_{C}′.

The stripper elements 210, 210′ are positioned in the first configuration 200 (FIG. 2) so as to clear debris between neighboring cutting element during shedding. The stripper elements 210, 210′ may rotate passively by the shredded article acting against them. Debris particles 230 generally fall below, but some debris particles 231 may become stuck or wedged between the sidewalls of neighboring cutter elements.

Considerable force may be needed to strip and/or remove debris particles 231 from the sidewalls of the cutter elements and/or between neighboring cutter elements Contact of the debris removal surface 214, 214′ with the debris particle 231 generates a force F_{D}, F_{D}′. Increasing the article thickness (e.g., the sheet count) may increase the size of the debris particles 231 which increases the force F_{D}, F_{D}′ applied to the stripping element. This force F_{D}, F_{D}′ acts upon the lower portion 212, 212′ of the stripper elements which generates a corresponding moment M_{S}, M_{S}′ in the stripper elements causing them to rotate outwardly, and thus, closing the opening of the article entry passage 226 between upper portions of the first and second sets of stripper elements.

Moment M_{S}, M_{S}′ create similar forces F_{S}, F_{S}′ at the article bearing surface 219, 219′ of the upper portions of the stripper elements. These forces F_{S}, F_{S}′ push against the opposite surfaces of the article. In turn, a slight frictional force F_{F}, F_{F}′ may be generated due to the contact of the article bearing surface 219, 219′ of the stripper elements and the sheet S which tends to resist the movement of the sheet S toward the cutter elements. Together the downwardly acting force F_{C}, F_{C}′ and the frictional force F_{F}, F_{F}′ create a slight tension T in the sheet S.

The tension T on the incoming sheet S improves the article shredding efficiency, thus preventing free flutter of the sheet during shredding. In particular, the tension T helps to groom the sheet S by flattening it out to more efficiently prevent free flutter of the sheet during shredding. This may reduce noises that may be ordinarily generated during shredding due to flutter of the sheet S.

If the user chooses to reverse the direction of the cutter elements, for example to remove a jam, the stripper elements 210, 210′ may be positioned in the second configuration 300 (FIG. 3) so as to permit article removal.

The rotation of the cutter elements in the reverse direction, now reverses the (direction of) moment M_{C}, M_{C}′ and the force F_{C}, F_{C}′ which had previously pulled the sheet S into the shedding assembly. Thus, the sheet S will be pushed upwardly and away of the shredding assembly. The user might also pull on the exposed surface of the sheet to assist removal. These forces on the sheet S now help to wedge apart the article bearing surface of the upper portions of the stripper elements. In addition to rotation of the stripper elements, as discussed above, the weight of the stripper elements themselves might also help to bias or urge them apart. Thus, the upper portions of the stripper elements may rotate outwardly.

Moreover, since the direction of the cutter elements is reversed, the force F_{D}, F_{D}′ due to the debris particles 231 contacting the debris removal surface is removed, effectively removing the moment M_{S}, M_{S}′ in the stripping element, the force F_{S}, F_{S}′ pushing again the article, and the frictional forces F_{F}, F_{F}′ on the article.

As such, the article bearing surfaces are moved sufficiently away from the article, and no longer contact the article. This facilitate easy jam removal.

The various components of the shredding assembly, may be formed by suitable materials, as will be appreciated by those skilled in the art. For example, cutter elements may be formed form suitable materials (e.g., steel) which may be tempered or otherwise heat-treated to provide hard and durable cutting edges. The stripper elements may be formed of rigid materials, such as metal (e.g., steel or aluminum) or engineering plastics.

While this disclosure has been described in connection with what is presently considered to be the most practical embodiment, it is to be understood that it is capable of further modifications and is not to be limited to the disclosed embodiment, and this application is intended to cover any variations, uses, equivalent arrangements or adaptations of the disclosure following, in general, the principles of the invention and including such departures from the present disclosure as come within known or customary practice in the art to which the disclosure pertains, and as may be applied to the essential features hereinbefore set forth and followed in the spirit and scope of the appended claims.

What is claimed is:

1. A shredder assembly comprising:
a plurality of cutter elements provided in a spaced apart manner configured to shred an article; and
a plurality of stripper elements, each positioned between neighboring cutter elements, that are configured to remove debris particles stuck on the sidewalls of the cutter elements and/or between neighboring cutter elements, wherein the stripper elements are mounted for movement between:
(i) a shredding configuration when the cutter elements are rotated in a forward direction, wherein upper portions of the stripper elements are urged toward an article to be shredded; and
(ii) a reversing configuration, when the cutter elements are rotated in a reverse direction, the upper portions of the stripper elements are urged away from an article being reverse fed from the cutter elements.

2. The shredder assembly according to claim 1, wherein the stripper elements are biased so as to urge them away from the article to be shredded.

3. The shredder assembly according to claim 2, wherein the stripper elements are spring-loaded.

4. The shredder assembly according to claim 1, wherein top portions of the stripping element comprise an article bearing surface configured to contact the article to be shredded in the first configuration.

5. The shredder assembly according to claim 4, wherein the article bearing surfaces do not contact the article to be shredded in the second configuration.

6. The shredder assembly according to claim 1, wherein a central portion of the stripper elements may be provided with a suitable bearing structure or surface to reduce wear.

7. The shredder assembly according to claim 1, further comprising at least one stop configured to limit the range of motion of the stripper elements.

8. The shredder assembly according to claim 7, wherein the stripper elements comprise a slot in which the stop is received.

9. The shredder assembly according to claim 7, wherein the stop comprises one or more of a block, detent, pin, bar, bumper, or spring.

10. The shredder according to claim 1, wherein the stripper elements are configured to rotate about the same axis of rotation as the cutter elements.

11. The shredder according to claim 1, wherein there are two sets of cutter elements and stripper elements, respectively, the first set of cutter elements interleaved with the second set of cutter elements.

12. A method of shredding comprising:
inserting an article to be shredded into a shredding assembly having a plurality of cutter elements provided in a spaced apart manner, and a plurality of stripper elements, each positioned between adjacent cutter elements, that are configured to remove debris particles stuck on the sidewalls of the cutter elements and/or between neighboring cutter elements,
wherein when the cutter elements are rotated in a forward direction, upper portions of the stripper elements are urged toward the article to be shredded.

13. The method according to claim 12, further comprising:
reversing the direction of the cutter elements,
wherein the upper portions of the stripper elements are urged away from the article to be shredded.

14. The method according to claim 13, further comprising:
removing the article being shredded from the shredding assembly.
